(19) United States
(12) Patent Application Publication
(10) Pub. No.: US 2018/0291671 A1
(43) Pub. Date: Oct. 11, 2018

(54) APPARATUS FOR PROVIDING A RESPIRATORY MASK IN A VEHICLE, AND METHOD FOR OPERATING SUCH AN APPARATUS

(71) Applicant: FORD GLOBAL TECHNOLOGIES, LLC, Dearborn, MI (US)

(72) Inventors: Eike Schmidt, Koeln (DE); Volker Scheer, Roetgen (DE)

(21) Appl. No.: 15/928,784

(22) Filed: Mar. 22, 2018

(30) Foreign Application Priority Data
Apr. 10, 2017 (DE) 102017206134.0

(51) Int. Cl. E05F 15/70; B60R 7/08

(52) U.S. Cl. CPC E05F 15/70; E05Y 2400/44; E05Y 2900/53; B60R 7/08

(57) ABSTRACT

An apparatus for providing a respiratory mask in a vehicle includes (a) a storage section in which a number of respiratory masks can be deposited; (b) a cover, which can be moved between a closed position and an open position; (c) a closure mechanism, which acts in combination with the cover and which can be switched from a first state, in which the closure mechanism holds the cover in the closed position, to a second state, in which the closure mechanism releases the cover to move into the open position, and vice versa; and (d) a control unit. A method for operating such an apparatus is also provided.

### TECHNICAL FIELD

This document relates to an apparatus for providing a respiratory mask in a vehicle, and to a method for operating such an apparatus.

### BACKGROUND

In large and rapidly growing towns, in particular, there is frequently a high level of air pollution, such that the air quality is poor, resulting in health risks for the populations of these towns. The quality of the air in interiors of vehicles operated in these towns can be improved with appropriate filters. In the same way, the quality of the air in interiors of buildings located in these towns can be improved.

In many cases, however, it is not possible for the distance between the start and the destination to be covered entirely by vehicle. If it is assumed that the start of a car journey begins in the home underground garage, it is usually not necessary to leave the building. If the destination is located in a pedestrian zone, or if there are no parking places available in the immediate vicinity of the destination, then a distance of greater or lesser extent must be covered outdoors, where the person concerned is exposed to the poor-quality air. In order to protect themselves against the health-damaging substances that are present in increased concentration in the air, the person concerned may put on, for example, a respiratory mask, which covers the mouth and nose, and which has a filter unit that prevents, or at least significantly reduces, the penetration of the health-damaging substances into the respiratory tract. Such respiratory masks are frequently realized as disposable products.

In order to achieve effective protection against the health-damaging substances it is necessary, on the one hand, that such respiratory masks are carried in sufficient quantities in the vehicle and that, on the other hand, it is ensured that the vehicle passengers in question also remember to put on the respiratory masks upon leaving the vehicle. JP 2015 039 976 A and CN 202794147 describe apparatuses by which the air quality outside the vehicle is determined. Depending on the result, the apparatus disclosed in JP 2015 039 976 A issues a recommendation to put on the respiratory mask. However, the apparatus cannot ensure that the passengers of the vehicle also actually follow the recommendation to put on a respiratory mask upon leaving the vehicle.

### SUMMARY

The objective hereof is to specify an apparatus and a method by which the likelihood of the passengers following the recommendation, to put on a respiratory mask upon leaving the vehicle, can be significantly increased.

This objective is achieved by the features specified in the following claims.

An embodiment relates to an apparatus for providing a respiratory mask in a vehicle, comprising a storage section, disposed in the vehicle in which a number of respiratory masks can be deposited, a cover, which can be moved between a closed position, in which the cover closes the storage section, and an open position, in which the cover enables access to the storage section, a closure mechanism, which acts in combination with the cover and which can be switched from a first state, in which the closure mechanism holds the cover in the closed position, to a second state, in which the closure mechanism releases the cover to move into the open position, and vice versa, and a control unit, by means of which the closure mechanism can be switched, under predefinable conditions, from the first state to the second state, and vice versa.

Respiratory masks are to be understood to mean all masks that enable the inhaled air to be filtered, in order to avoid the inhalation of health-damaging substances. In particular, the term respiratory mask is to be understood to include also a mouth protection.

According to the proposal, a storage section is provided in the vehicle, in which the respiratory masks can be stored. The storage section alone is instrumental in increasing the likelihood of the passengers actually also putting on the respiratory masks upon leaving the vehicle. Known vehicles do not have a storage section provided exclusively for the respiratory masks. Consequently, the respiratory masks are stored in a variety of places in the vehicle, for example in storage compartments or in the glove compartment. Consequently, purposeful storage of the respiratory masks is not possible, with the result that it is not noticed if there are no more respiratory masks present. Frequently, therefore, there arises the situation in which it is only upon getting out of the vehicle that it is noticed that there are no more respiratory masks. In contrast to this, according to the proposal, it is only necessary to inspect the storage section for the presence of respiratory masks, which increases the likelihood of a sufficient quantity of respiratory masks being carried in the vehicle. Moreover, the passenger knows where it is necessary to search for the respiratory mask, this reducing the amount of time required for putting on the respiratory mask and simplifying the procedure.

Furthermore, the storage section is opened under predefinable conditions. Such a condition may be that the engine remains switched off for a certain period of time, this indicating that the car journey has ended and the passengers will get out. The opening of the storage section reminds the passengers to put on a respiratory mask. This reduces the likelihood of the passengers forgetting to put on the respiratory masks.

According to a further embodiment, the apparatus has means for determining the air quality in the environment of the vehicle, the means acting in combination with the control unit. The means enable the air quality in the environment of the vehicle to be determined, for example in that the concentrations of nitrogen oxides, ozone, sulfur dioxide, carbon monoxide and/or fine dust are measured. Limit values may be stored on the control unit, which limit values determine the air quality, from the measured concentrations, in respect of whether the wearing of a respiratory mask is necessary or advisable. If this is the case, the predefinable condition is fulfilled, and the storage section is opened. In this embodiment, the access to the storage section is only enabled if this is rendered actually necessary by the air quality in the environment of the vehicle. The unnecessary use of respiratory masks is thereby prevented.

In a developed embodiment, the means may comprise sensors, fastened to the vehicle, by means of which the air quality can be determined. In this embodiment, it is possible for the air quality in the environment of the vehicle to be determined with great precision, such that the unnecessary use of respiratory masks can be prevented in a highly effective manner.

In the case of a developed embodiment, the means may comprise a communication device, by which communication can be established with external devices for the purpose of determining the air quality in the environment of the vehicle. The communication device renders possible access to stationary devices for determining the air quality, for example of measuring stations in the environment of the vehicle. In addition, data relating to air quality, stored in the Cloud, may be accessed. For this purpose, however, it is necessary to ascertain the current position of the vehicle to enable accessing of the data originating from measuring stations in the environment of the vehicle, and therefore also of relevance to the passengers. However, since modern vehicles usually have navigation systems, determination of the vehicle position is not a problem. If the vehicle does not have a navigation system, the approximate position may also be input manually. In this embodiment, the vehicle itself does not need to have any sensors of its own in order to enable the air quality to be determined, such that the production costs of the proposed apparatus are kept low. Moreover, there is no need to reserve space for the sensors in the installation space of the vehicle, which is of restricted size in any case. The measurement results of the measuring stations are usually more precise than those determined by sensors in the vehicle.

In the case of a further embodiment, the apparatus may have an input unit for inputting threshold values relating to the air quality. As already mentioned, limit values that, if exceeded, render it necessary or advisable to wear respiratory masks, may be stored in the control unit. These limit values may be based on the recommendations of health authorities. In this embodiment, however, the threshold value from which the predefinable condition under which the storage section is to be opened can be determined by the vehicle passenger themselves.

A developed embodiment is characterized in that the vehicle comprises a navigation system, acting in combination with the control unit, for determining the current position of the vehicle. In this embodiment, the current position of the vehicle may be taken into account, for example, for the purpose of accessing the data of the measuring stations in the environment of the vehicle. It is ensured that only relevant data are used, in order to enable access to the respiratory masks in the storage section. Taking account of the current position of the vehicle avoids the unnecessary use of respiratory masks. Moreover, the navigation system may be used to ascertain whether or not the car journey has ended. If the input destination has been reached, it may be assumed that the car journey has ended, such that the storage section can now be opened.

According to a further embodiment, the vehicle has a speed determination device, acting in combination with the control unit, for determining the speed and, in particular, a standstill state of the vehicle. The determination of the speed allows very accurate ascertainment of whether the car journey has or has not ended. Although this can also be achieved by means of a navigation system, determination of position by means of a navigation system is not so accurate, such that it is not always possible to distinguish between a standstill state and travel at very low speed. Furthermore, it may be the case that there is no satellite signal present, for example in underground garages. If known routes are travelled, the navigation system is frequently not activated for route guidance, and consequently no destination is input. In these cases, the speed determination device may be used to determine whether the car journey has or has not ended, and whether the storage section can be opened or not.

A further embodiment is characterized in that the vehicle has a number of vehicle doors and a vehicle-door state determination device for determining whether one or all of the vehicle doors is or are open. Open doors likewise indicate that the journey has ended, and the storage section can be opened. This applies, in particular, to the driver's door. Such vehicle-door state determination devices are usually present as standard in modern vehicles, such that there is no requirement for significant additional resource to realize this embodiment.

In a preferred embodiment, the vehicle has a speed determination device, acting in combination with the control unit, for determining the speed and, in particular, a standstill state of the vehicle, the speed determination device including at least one means for identifying the state of a parking brake and/or of a transmission and/or of a drive motor and/or of an ignition key. Identifying the state of a parking brake enables a standstill state of the vehicle to be detected. If the parking brake, in particular an electric parking brake, is activated, a vehicle standstill state may be assumed. Likewise, identifying the state of a transmission, for example an activated position P (park position) of an automatic transmission) enables a vehicle standstill state to be detected. The same applies to identifying a drive motor state, in particular a switched-off state, or a state of an ignition key, in particular a locked state.

A further embodiment is characterized in that the apparatus comprises at least one signal generator, disposed in the vehicle, for generating a signal by which the opened storage section can be indicated. For example, the signal generator may emit a warning tone, indicating to the passengers that storage section is open. This prevents the passengers from forgetting to put on the respiratory masks.

In a further embodiment, at least one of the signal generators may be realized as a light source, by means of which the storage section and/or the cover can be illuminated. An optical signal is thereby generated, indicating to the passengers that the storage section is open. This prevents the passengers from forgetting to put on the respiratory masks. The light source may be used to ascertain whether there are still respiratory masks present in the storage section. For this purpose, it is necessary only to provide a detector, which is set up such that, on the basis of the light conditions varying with the number of respiratory masks in the storage section, it can generate a corresponding signal that prompts the passengers to deposit new respiratory masks in the storage section.

In the case of a further embodiment, the apparatus may have a movement device for moving the cover between the open position and the closed position. By means of the movement device, the cover can be moved, in a manner that is noticeable by the passengers, between the open position and the closed position, thereby increasing the convenience of the proposed apparatus. The cover may be moved such that the passengers can reach comfortably into the storage section. The cover may be closed again automatically, for example after it has been ascertained that the vehicle doors have been closed again. This prevents the storage section from intentionally remaining open.

In a further embodiment, the movement device comprises at least one spring that acts in combination with the cover. The spring can store kinetic energy, such that this does not have to be supplied by an electric motor, with the result that the energy consumption can be kept low. Moreover, the spring functions independently of the state of the electric power supply network of the vehicle.

A method for operating an apparatus comprises the following steps:
moving the cover into the open position,
depositing a number of respiratory masks in the storage section,
moving the cover into the closed position,
switching the closure mechanism to the first state by means of the control unit, such that the cover is held in the closed position, and
switching the closure mechanism to the second state by means of the control unit when the predefined condition is fulfilled, as a result of which the cover is released to move into the open position.

The technical effects and advantages that can be achieved with the proposed method correspond to those disclosed for the present apparatus. In summary, it must be pointed out that, on the one hand, a storage section specially intended for the respiratory masks is provided in the vehicle, and on the other hand, as a result of the cover being moved into the open position, the passengers are provided with a signal prompting them to put on the respiratory masks. This reduces the likelihood of no new respiratory masks being stored in the vehicle when the old ones have been used up, and of the passengers forgetting to put on the respiratory masks upon leaving the vehicle.

A further development of the method, in which the apparatus has means for determining the air quality in the environment of the vehicle, and an input unit for inputting threshold values relating to the air quality, comprises the following steps:
inputting threshold values relating to the air quality, by use of the input unit,
checking, by means of the control unit, whether the threshold values are or are not being exceeded, and
if the threshold values are being exceeded, switching the closure mechanism to the second state, by means of the control unit.

In this case, the vehicle passenger has the possibility to select for themselves the predefinable conditions under which the storage section opens, in that the passenger themselves inputs threshold values relating to the air quality. The apparatus may be factory-set such that the limit values are based on recommendations of health authorities or other institutions. In this development, the passenger can choose whether to take a cautious or liberal approach to these limit values.

A further development of the method, in which the vehicle has a speed determination device, acting in combination with the control unit, for determining the speed and, in particular, a standstill state of the vehicle, comprises the following steps:
checking whether the speed of the vehicle is zero, and
if the speed of the vehicle is zero, switching the closure mechanism to the second state, by means of the control unit.

In this case, the predefinable conditions also include the criterion of whether the vehicle is or is not at a standstill. Thus, for example, it is possible to define a period of time for how long the vehicle must be at a standstill in order to open the storage section. This prevents the storage section being opened, for example, at a red traffic light. Other criteria, such as the opening of one or more of the vehicle doors, may be used to prevent inappropriate opening of the storage section.

In accordance with an additional aspect, a vehicle is provided comprising an apparatus as per any one of the previously described embodiments. The technical effects and advantages that can be achieved with the proposed vehicle correspond to those disclosed for the present apparatus.

### BRIEF DESCRIPTION OF THE DRAWING FIGURES

Exemplary embodiments of the apparatus and method are explained in greater detail in the following with reference to the appended drawings. There are shown:

FIG. 1 illustrates a vehicle having an exemplary embodiment of a proposed apparatus for providing a respiratory mask, and

FIG. 2 illustrates a flow diagram of an embodiment of a proposed method for operating the apparatus represented in FIG. 1.

### DETAILED DESCRIPTION

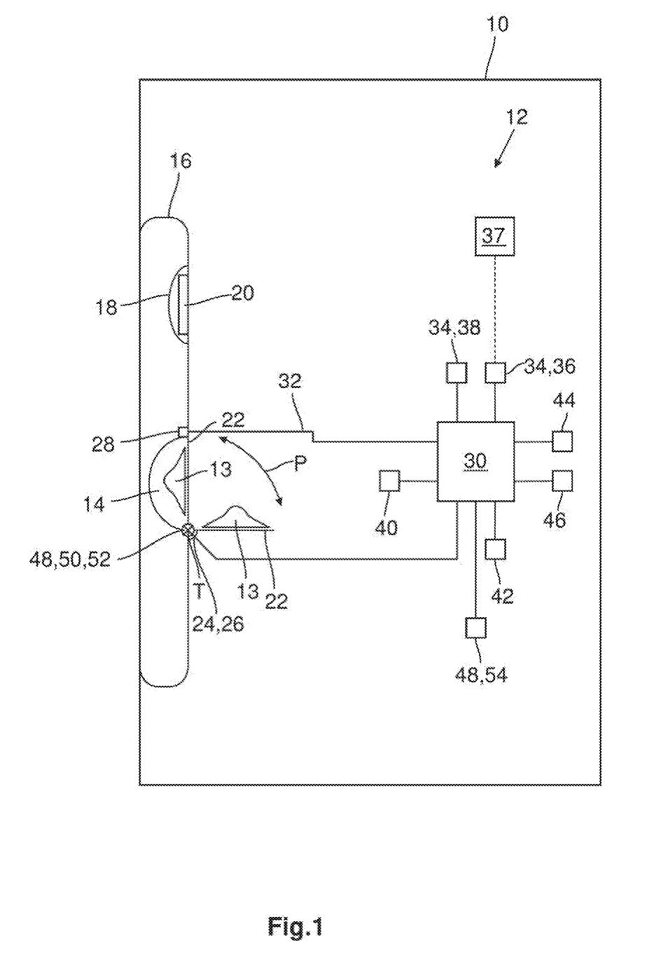

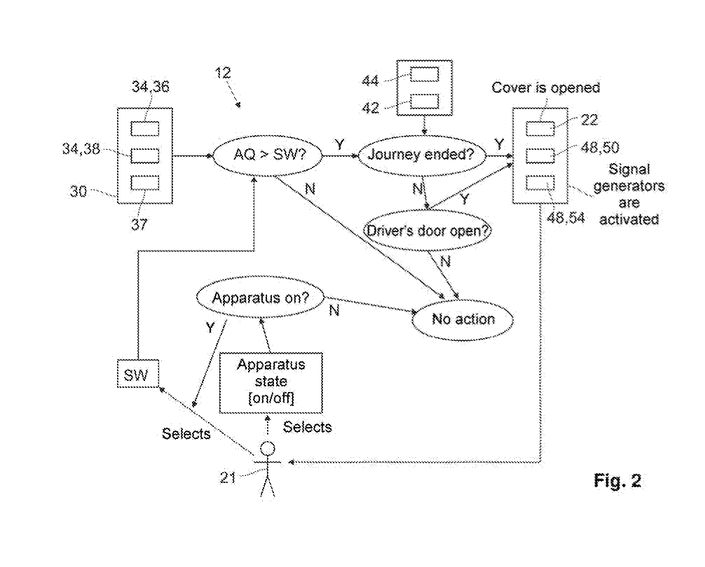

Shown schematically in FIG. 1 is a vehicle 10, having an apparatus 12 for providing a number of respiratory masks 13. The apparatus 12 comprises at least one storage section 14, which is disposed in a vehicle door 16. The vehicle door 16 comprises a recess 18, disposed in which there is an unlocking lever 20 by means of which a passenger 21, not represented (see FIG. 2) of the vehicle 10 can open the vehicle door 16. The vehicle door 16 in this case is represented by means of a schematic sectional representation, the section plane being approximately perpendicular to the position of use of the vehicle 10. Such a storage section 14 may be disposed in each of the vehicle doors 16 of the respective vehicle 10, and also in the tailgate.

The apparatus 12 furthermore comprises a cover 22 that can be moved between an open position and a closed position. In the closed position, the cover 22 closes the storage section 14, whereas in the open position the cover 22 enables access to the storage section 14. It can be seen from FIG. 1 that the cover 22 is mounted so as to be rotatable about a rotation axis T. The rotation capability of the cover 22 is indicated by the arrow P.

The apparatus 12 comprises a movement device 24, by which the cover 22 can be moved from the closed position into the open position. In this case, the movement device 24 comprises a spring 26 that is biased in the closed position. The apparatus 12 furthermore has a closure mechanism 28, which can be switched between a first state and a second state. In the exemplary embodiment represented, the two states are not distinguishable from the outside, since they may differ, for example, in an altered electric current feed or magnetization. It is also possible, however, that an actuator, not represented, is shifted. To that extent, switching is also to be understood to mean the shifting of the actuator between two positions, which are assigned to the two states. The switching is effected by use of a control unit 30, which is connected to the closure mechanism 28 via electrical lines 32.

In the exemplary embodiment represented, the spring 26 is biased in the closed position of the cover 22. The closure mechanism 28 is in the first state, in which it holds the cover 22 in the closed position. If a predefinable condition, explained later in greater detail, is fulfilled, the control unit 30 switches the closure mechanism 28 to the second state, in which it releases the cover 22 to move into the open position. The movement is effected by the spring 26. In order to move the cover 22 back into the closed position, the passenger 21 must move the cover 22 against the spring force. Alternatively, the movement device 24 may comprise an electric motor, not shown, that moves the cover 22 back into the closed position.

The respiratory masks 13 are fixed on the cover 22 by means of a holder, not represented. In the closed position, the cover 22 is approximately in a vertical position, whereas in the open position it is approximately in a horizontal position. In the horizontal position, the passenger 21 can comfortably remove the respiratory masks 13.

The apparatus 12 furthermore has means 34 for determining the air quality AQ. These means 34 may comprise a communication device 36, by means of which wireless communication may be established to external devices 37 for the purpose of determining the air quality AQ. In this case, the air quality AQ is not effected on the vehicle 10 itself, but data provided by the external devices 37 are accessed. Also possible are access to cloud-based services or other mobile measuring devices, such as vehicles in the environment. Via the communication device 36, these means 34 are connected to the apparatus 12, and are thus part of the apparatus 12. In the exemplary embodiment represented, the apparatus 12 additionally has sensors 38, disposed in the vehicle 10, for determining the air quality AQ. Parameters by which the air quality AQ can be determined are, for example, the concentrations of ozone, nitrogen oxides, sulfur dioxide, carbon monoxide and fine dust.

The apparatus 12 additionally has an input unit 40, by means of which the passenger 21 can input threshold values SW that relate to the air quality AQ. The passenger can thus input, for example, concentration values in respect of the parameters mentioned above. The input unit 40 may be integrated into the interfaces or displays that modern vehicles have as standard.

The vehicle 10 additionally has a navigation system 42 that acts in combination with the control unit 30, such that the control unit 30 receives information concerning the current position of the vehicle 10. Furthermore, the vehicle 10 has a speed determination device 44, by means of which the current speed, and in particular a standstill state of the vehicle 10, can be determined. The speed determination device 44 also acts in combination with the control unit 30, such that the latter receives information concerning the current speed, and in particular a standstill state of the vehicle 10. The vehicle 10 additionally comprises a vehicle-door state determination device 46, by means of which it can be ascertained whether or not one or more vehicle doors 16 is or are open. All of these components are usually present as standard in any modern vehicle 10, such that, as a result, the provision of the proposed apparatus 12 is not rendered complicated and expensive.

The apparatus 12 furthermore comprises a number of signal generators 48, by means of which a signal, indicating the open storage section 14, can be generated. In the example represented, one of the signal generators 48 is realized as a light source 50 that, when the storage section 14 is open, illuminates both the storage section 14 and the cover 22 and the respiratory masks 13 fixed thereon. The light source 50 may be switched on and off by the control unit 30, but may also be switched only solely by the moving of the cover 22 into the open position. Integrated into the light source 50 is a detector 52, which senses the reflected light and from this can deduce whether or not there are respiratory masks 13 present. The detector 52 generates corresponding signals, which are then relayed to the control unit 30, which can generate an indication to the passenger 21.

A further signal generator 48 is realized as a loudspeaker 54, which can generate an acoustic signal that indicates the open storage section 14.

Represented in FIG. 2 is a flow chart, which illustrates an embodiment of a method by which the proposed apparatus can be operated. It is assumed that the cover 22 is initially in the closed position. The passenger 21, in particular the driver, first has the possibility to activate or switch off the apparatus 12 via the input unit 40. If the passenger has switched on the input unit, the passenger has the possibility to input threshold values SW that relate to the air quality AQ. The air quality AQ in the environment of the vehicle 10 is determined continuous during the journey, in particular by means of the sensors 38 built into the vehicle 10 and/or by means of the communication with the external devices 37 and/or with cloud-based or other mobile measuring devices. The results of the determination of the air quality AQ are transmitted to the control unit 30.

If the measured concentrations are over the threshold values SW, the control unit 30 checks whether the journey has ended. For this purpose, the control unit 30 can access the navigation system 42 and check whether the current location matches the input destination or an intermediate destination. Furthermore, the control unit 30 can act in combination with the speed determination device 44 to ascertain whether the vehicle 10 is at a standstill. On the basis of these queries, the control unit 30 can draw an inference on whether or not the journey has ended. If the inference cannot be drawn in a definite manner, the control unit 30 can poll the vehicle-door state determination device 46 to determine whether at least one of the vehicle doors 16 is open. The driver's door is of particular interest in this case, since the opening of the driver's door is a particularly strong indication that the journey has ended. If the control unit 30 comes to the conclusion that the journey has ended, it switches the closure mechanism 28, at least briefly, to the second state, such that the cover 22 is put into the open position by means of the movement device 24. At the same time, the signal generator 48, realized as the light source 50, is activated, such that the storage section 14 and/or the cover 22 are/is illuminated. In addition, the signal 48, realized as the loudspeaker 54, may be activated, as a result of which an indication tone is generated. The passengers 21 can now remove the respiratory masks 13 from the cover 22, put them on and, being protected, move away from the vehicle 10.

As long as the threshold values SW are not exceeded, or the journey is not ended, the storage section 14 is not opened.

As already mentioned, such a storage section 14 may be disposed in each of the vehicle doors 16. Modern vehicles have sensors 38 that can ascertain whether a vehicle seat is or is not occupied by a passenger 21. If the control unit 30 ascertains that a particular vehicle seat is not occupied, the cover 22 of the storage section 14 assigned to this vehicle seat is not opened, even when the conditions described above are fulfilled.

What is claimed:

1. An apparatus for providing a respiratory mask in a vehicle, comprising:
a storage section, disposed in the vehicle, in which a number of respiratory masks are deposited;
a cover, displaceable between a closed position, in which the cover closes the storage section, and an open position, in which the cover enables access to the storage section;
a closure mechanism, which acts in combination with the cover and which is switchable from a first state, in which the closure mechanism holds the cover in the closed position, to a second state, in which the closure mechanism releases the cover to move into the open position, and vice versa; and
a control unit, configured to switch the closure mechanism, under predefinable conditions, from the first state to the second state, and vice versa.

2. The apparatus as claimed in claim 1, further including an air quality monitoring device for determining air quality in an environment of the vehicle and providing air quality data to said control unit.

3. The apparatus as claimed in claim 2, wherein said air quality monitoring device is selected from a group consisting of air quality sensors fastened to the vehicle, a communication device by which communication is established with external devices for determining the air quality in the environment of the vehicle, and combinations thereof.

4. The apparatus as claimed in claim 3, further including an input unit for inputting threshold values relating to the air quality.

5. The apparatus as claimed in claim 4, wherein the vehicle comprises a navigation system, acting in combination with the control unit, for determining a current position of the vehicle.

6. The apparatus of claim 4, wherein the vehicle has a speed determination device, acting in combination with the control unit, for determining a speed of the vehicle.

7. The apparatus of claim 4, wherein the vehicle has a number of vehicle doors and a vehicle-door state determination device for determining whether one or all of the vehicle doors is or are open.

8. The apparatus as claimed in claim 5, wherein the vehicle has a speed determination device, acting in combination with the control unit, for determining speed of the vehicle, the speed determination device including at least one monitoring device for identifying a state of one of a group of parameters consisting of parking brake status, transmission status, drive motor status, ignition key status and combinations thereof.

9. The apparatus as claimed in claim 8, further including at least one signal generator, disposed in the vehicle, for generating a signal by which an opened storage section is indicated.

10. The apparatus as claimed in claim 9, wherein said at least one signal generator is realized as a light source, by which (a) the storage section, (b) the cover or (c) the storage section and the cover is illuminated.

11. The apparatus as claimed in claim 10, further including a movement device for moving the cover between the open position and the closed position.

12. The apparatus as claimed in claim 11, wherein the movement device comprises at least one spring that acts in combination with the cover.

13. A method for operating an apparatus, comprising:
moving a cover of a storage section into an open position;
depositing a number of respiratory masks in the storage section;
moving the cover into a closed position;
switching, by a control unit, a closure mechanism to a first state, such that the cover is held in the closed position; and
switching, by said control unit, the closure mechanism to a second state when a predefined condition is fulfilled, as a result of which the cover is released to move into the open position.

14. The method as claimed in claim 13, further including:
inputting, by an input unit, threshold values relating to air quality;
checking, by the control unit, whether the threshold values are being exceeded; and
if the threshold values are being exceeded, switching, by the control unit, the closure mechanism to the second state.

15. The method as claimed in claim 14, further including:
checking, by a speed determination device, whether a speed of a vehicle is zero; and
if the speed of the vehicle is zero, switching, by the control unit, the closure mechanism to the second state.

16. A vehicle, incorporating the apparatus of claim 1.
